(19) United States
(12) Patent Application Publication
(10) Pub. No.: US 2001/0041307 A1
(43) Pub. Date: Nov. 15, 2001

(54) Three-dimensional microstructure

(76) Inventors: Robert Arthur Lee, East Burwood (AU); Patrick Leech, Murrumbeena (AU); Xiaoping Yang, Endeavour Hills (AU)

Correspondence Address: Richard J. Streit, Ladas & Parry, 224 South Michigan Avenue, Suite 1200, Chicago, IL, 60604, US

(21) Appl. No.: 09/792,969

(22) Filed: Feb. 26, 2001

Related U.S. Application Data
(63) Continuation of application No. PCT/AU99/00741, filed on Sep. 8, 1999.

(30) Foreign Application Priority Data
Sep. 8, 1998 (AU) PP5747
Dec. 1, 1998 (AU) PP7442

(51) Int. Cl. G03C 5/00

(52) U.S. Cl. 430/312

(57) ABSTRACT

A three-dimensional microstructure includes a plurality of structure elements, each structure element having a width, a length and a height, wherein a significant proportion of the structure elements have height dimensions which exceed their width and length dimensions. A method of fabricating such a microstructure includes the steps of: forming a mask with a plurality of regions, each region having a predetermined degree of transparency to UV radiation; providing a substrate (5) coated with a thick layer (6) of UV resist material; using UV radiation to irradiate through each of the regions of the mask a corresponding region of the layer of UV resist; and developing the layer of UV resist to remove irradiated regions, wherein the depth of each region is dependent upon the degree of transparency of the corresponding region of the mask.

This invention relates to a three dimensional microstructure. It relates particularly but not exclusively to a three dimensional microstructure in which a significant proportion of structure elements have height dimensions which exceed their width and length dimensions.

There are numerous uses for microstructures, ranging from integrated circuits to security devices. International Patent Application PCT/AU98/00821, the contents of which are hereby incorporated herein by reference, describes a micrographic security device which generates a grey scale image when illuminated by a light source and viewed by an observer. When the surface pattern of the micrographic device is magnified, it becomes apparent that the grey scale image is composed of a large number of regions, each region having a particular grey-scale value, and each region also containing graphic elements, line art or images represented in microscopic size.

International Patent Application PCT/AU90/00395, the contents of which are also incorporated herein by reference, discloses an optically variable microstructure which can be used for generating an optical diffraction image. Electron beam lithography is used to write a surface pattern into a layer of electron beam resist material, which is then developed so that regions of resist exposed to electron beam radiation are dissolved away, leaving a pattern of pits or troughs in the surface. Appropriate use of electron beam lithography can result in finely detailed diffractive microstructures. Essentially the same electron beam lithography technique may be used to create the micrographic security device of International Patent Application PCT/AU98/00821, referred to above. Other similar microstructures are described in International Patent Application PCT/AU94/00441.

However, although such microstructures incorporate pits and troughs, all pits and troughs are essentially of the same depth, and the microstructure is essentially a two dimensional microstructure with two different levels, an upper level corresponding with the top of ridges and mounds on the microstructure, and a lower level corresponding with the bottom of pits, troughs and grooves. Where, as in the security device described in International Patent Application PCT/AU98/00821, different regions of the structure appear to have different “darkness” or “brightness” characteristics, this is achieved by varying the degree of complexity of the structure within regions, and not by varying the depth of those regions. Conventional microstructure formation processes do not allow for significant depth variation, with the maximum depth of any structural element being around 0.5 micron.

According to a first aspect of the present invention, there is provided a method of fabricating a microstructure including the steps of:

(a) forming a mask with a plurality of regions, each region having a predetermined degree of transparency to ultra violet (UV) radiation;

(b) providing a substrate coated with a thick layer of UV resist material;

(c) irradiating through each of the regions of the mask a corresponding region of the layer of UV resist; and

(d) developing the layer of UV resist to remove irradiated regions, wherein the depth of each region is dependent upon the degree of transparency of the corresponding region of the mask.

The step of forming a mask may be performed in any suitable manner. In an especially preferred arrangement, each region of the mask consists of one of:

(a) material which is opaque to transmission of UV radiation, but which includes a plurality of transparent holes, with the overall degree of transparency of the region being determined by the number and size of the holes; or

(b) material which is transparent to UV radiation, but which includes a plurality of opaque spots, with the overall degree of transparency of the region being determined by the number and size of the spots; or

(c) material which is opaque to the transmission of UV radiation, but which includes a plurality of transparent strips or tracks, with the overall degree of transparency of the region being determined by the width and variation in width of each track; or

(d) material which is transparent to UV radiation, but which includes a plurality of opaque strips or tracks, with the overall degree of transparency of the region being determined by the width and variation in width of each track.

In this arrangement, it is especially preferred that the holes or spots have the same constant spacing for each region and the overall degree of transparency of each region is determined by the size of the holes or spots.

The layer of UV resist may be of any suitable thickness. It is preferred that the layer be greater than 1 micron in thickness. It is especially preferred that the layer have a thickness of 10 micron or greater.

The layer of UV resist may comprise two or more types of different resist in individual layers, allowing variation in the physical characteristics of structure elements at different depths in the structure.

The method of fabricating a microstructure may include the further additional step of replicating the microstructure by means of reactive ion etching and/or electroplating.

According to a second aspect of the invention, there is provided a three-dimensional microstructure including a plurality of structure elements, each structure element having a width, a length and a height, wherein a significant proportion of the structure elements have height dimensions which exceed their width and length dimensions.

The structure elements may have any suitable dimensions. It is preferred that a majority of the structure elements have height dimensions which exceed their width and length dimensions by a factor of more than 3. Optionally, the structure elements may have fixed length and width dimensions but varying height dimensions.

It is preferred that the microstructure, when viewed by an observer, appears to contain one or more of: artistic patterns, line drawings, lettering, positive and negative photographic images, facial images, geometric patterns, company logos and optical elements. These effects are observed as a result of light being reflected and/or diffusely scattered from the topographic features of the structure elements.

The microstructure may optionally incorporate a “switch” effect, wherein a first image is observed when the microstructure is viewed from a first viewing direction, and the first image switches to a second image when viewing angle moves from the first direction to a second direction, this effect being achieved as a result of sloped surfaces being provided on the tops of individual structure elements. The slope will be at a different angle for each of the two images. A similar technique may be used to incorporate more than two images.

The microstructure may optionally incorporate a diffractive image as well as a non-diffractive image. In this arrangement the microstructure generates one or more non-diffractive images which are attributable to light being reflected and/or diffusely scattered from the topographic features of high-aspect structure elements of the type defined in claim 1, and also one or more diffractive images, the diffractive images being generated as a result of regions of diffractive structure elements being interposed between regions of high-aspect structure elements.

In a preferred arrangement of this aspect of the invention, the microstructure is a representation of a two-dimensional image composed of grey-scale pixels or tracks wherein each pixel or track in the two-dimensional image is represented by a structure element in the three-dimensional image and the grey-scale value of each pixel or track is represented by the height of the corresponding structure element. Thus, when the microstructure is observed under appropriate viewing conditions, it appears to show a two-dimensional grey-scale image composed of pixels or tracks, with the “brightness” of each pixel or track being related to the height of the corresponding structure element.

It will be appreciated that the present invention has several possible applications. One such application is in applying a microstructure directly to the surface of a document such as a bank note, credit card or share certificate, to create a security device on the document by stamping the microstructure onto the surface of the document. According to present practice, because of the relatively shallow nature of microstructures, security devices are applied to documents by stamping the structure onto a transfer foil and then affixing the foil to the document. The present invention allows for the production of relatively deep microstructures, which can be used to stamp a microstructure onto a foil which has already been applied to the surface of a document, thereby considerably reducing production costs.

Another application of the invention is in creating an extremely finely detailed master plate for an intaglio printing process. Subject to the availability of inks and other materials of an appropriately fine quality, microstructures made according to the present invention can be used to print significantly finer images than can be printed using conventional plate-making processes.

The invention will hereafter be described in greater detail by reference to the attached drawings which show example forms of the invention. It is to be understood that the particularity of those drawings does not supersede the generality of the preceding description of the invention.

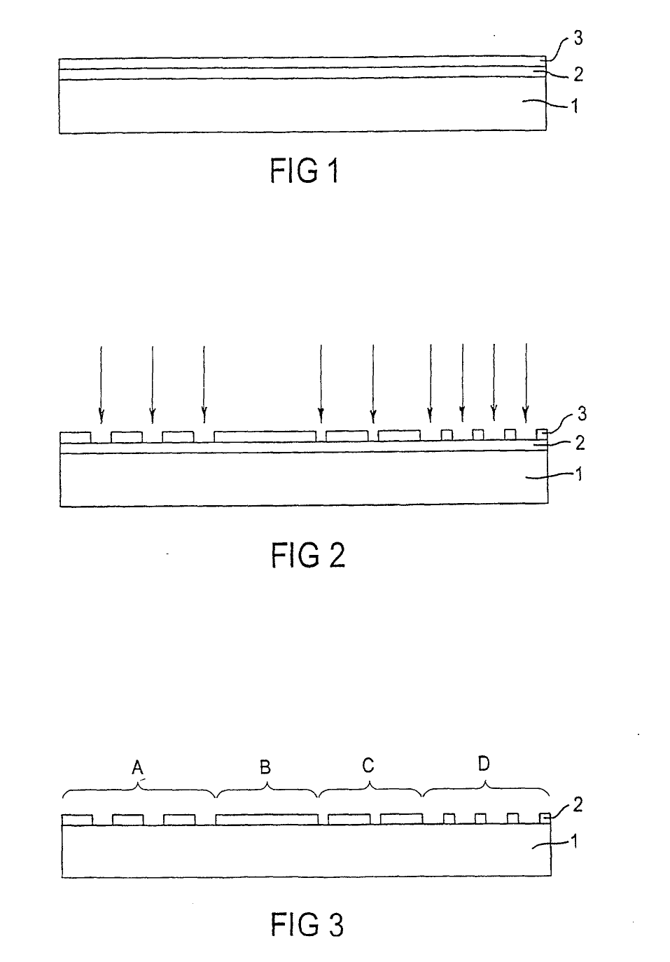

FIG. 1 shows a substrate with a layer of Chromium and a layer of electron beam resist, ready for the first stage of producing a mask for use in fabricating a microstructure according to an embodiment of the invention.

FIG. 2 shows the substrate and layers of FIG. 1 after selective exposure to an electron beam.

FIG. 3 shows the finished mask, consisting of the substrate of FIG. 2 after a further process of chromium etching followed by dissolving the remainder of the electron beam resist layer.

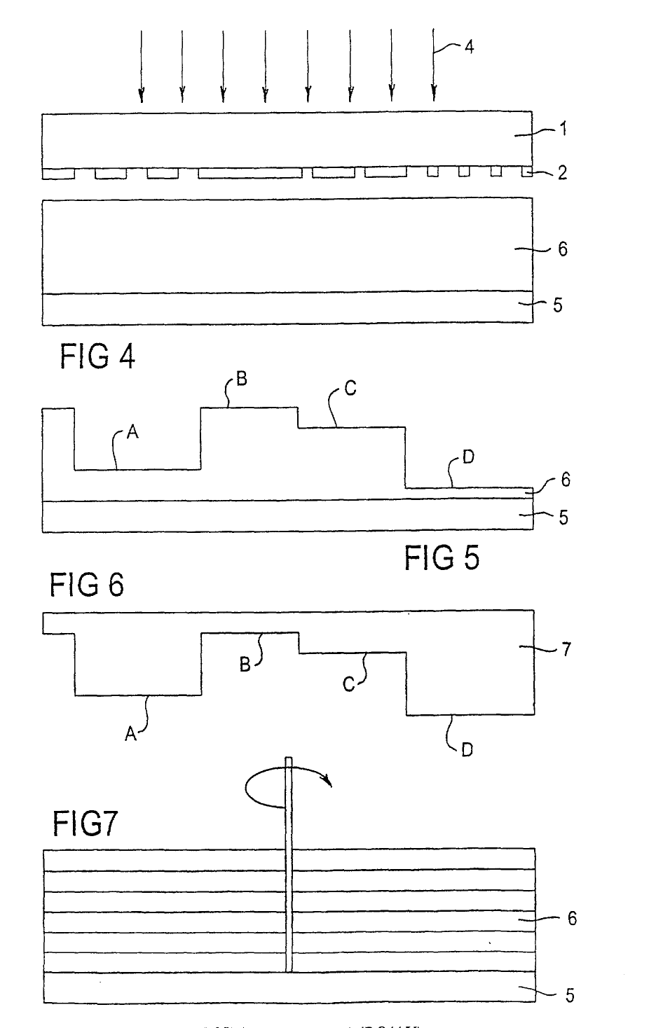

FIG. 4 shows the mask of FIG. 3 (inverted) in use in a UV irradiation step, together with a substrate and a thick layer of photo-resist, as part of a process of fabricating a microstructure according to an embodiment of the invention.

FIG. 5 shows the substrate and thick layer of photo-resist of FIG. 4 after UV irradiation and the application of a developer.

FIG. 6 shows a nickel shim formed from the photo-resist image of FIG. 5.

FIG. 7 illustrates a method of creating a thick layer of photo-resist.

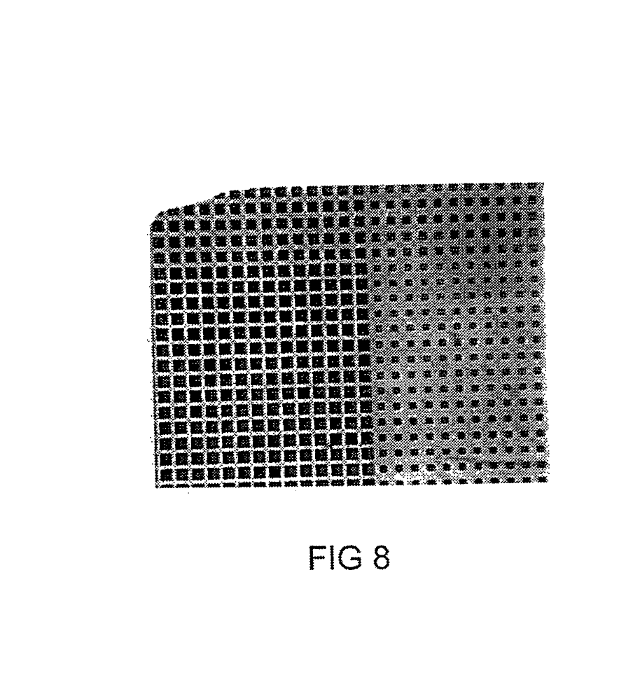

FIG. 8 shows a microstructure according to an embodiment of the invention.

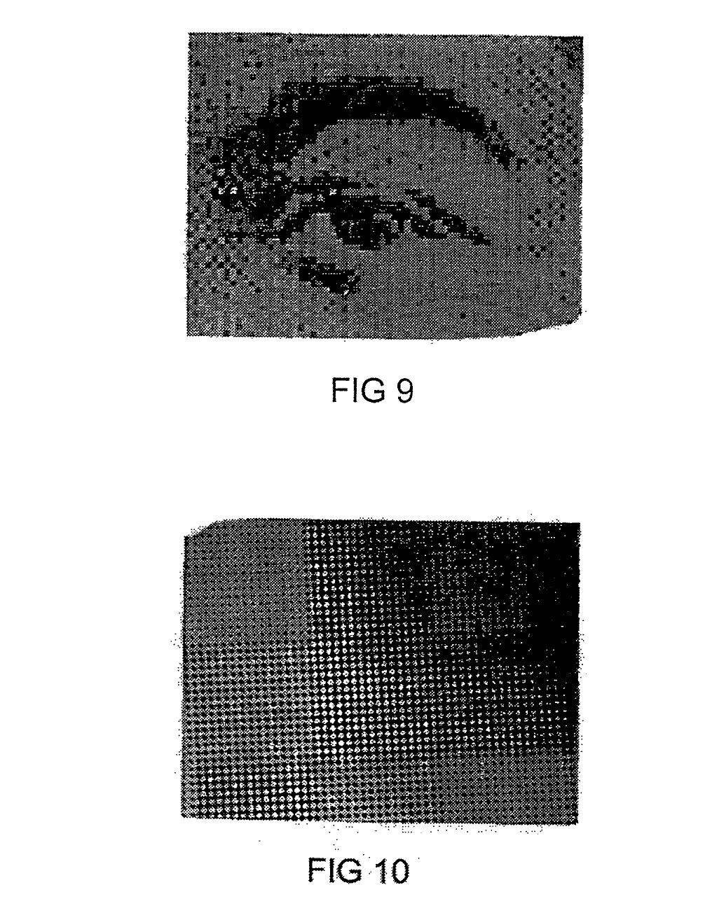

FIG. 9 shows another microstructure according to an embodiment of the invention.

FIG. 10 shows the microstructure of FIG. 9 at a greater magnification, with individual structure elements being discernible.

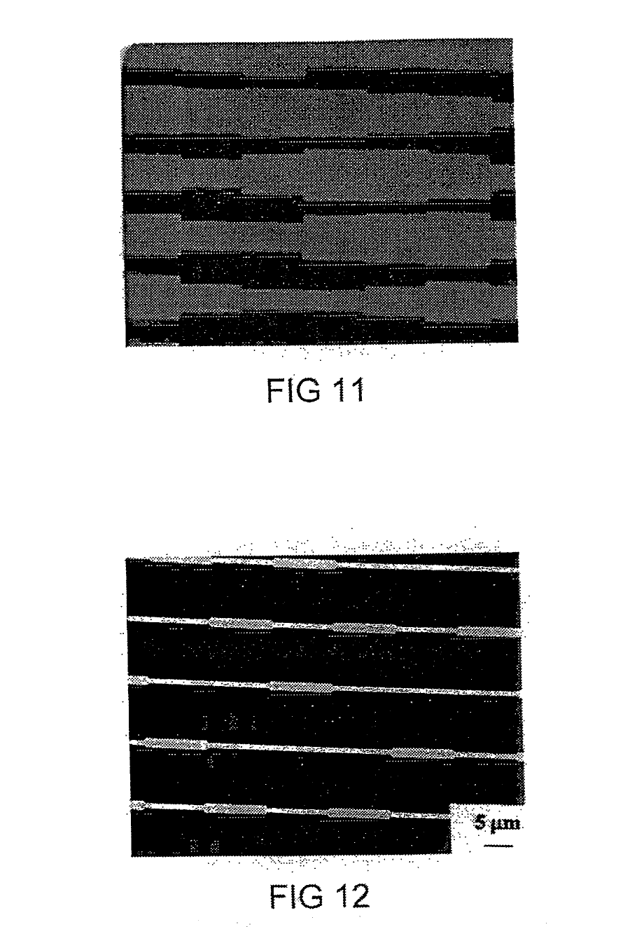

FIG. 11 shows a microstructure element according to another embodiment of the invention.

FIG. 12 shows another microstructure element according to another embodiment of the invention.

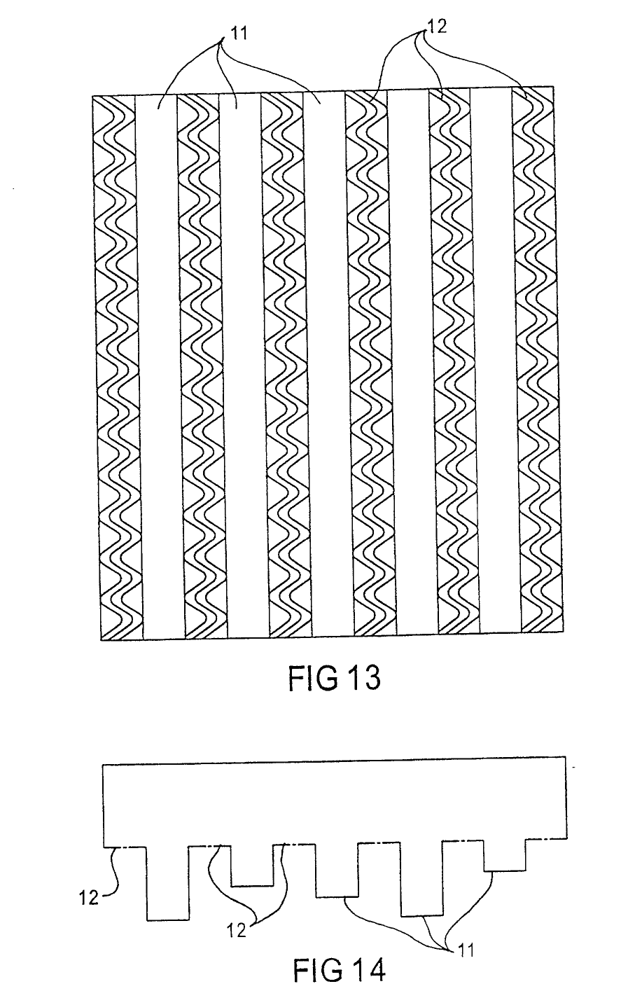

FIG. 13 shows a microstructure according to another embodiment of the invention.

FIG. 14 shows a cross-section of an embossing die suitable for creating the embodiment of FIG. 13.

FIGS. 1 to 6 show a process according to one aspect of the invention for creating a nickel shim which can subsequently be used to replicate microstructures. FIGS. 1 to 3 show the steps in forming a mask, and FIGS. 4 to 6 show the use of that mask in creating the microstructure on the nickel shim.

In FIG. 1 there is shown a UV-transparent quartz substrate 1, coated with a layer of chromium 2 and a layer of electron beam resist 3. A predetermined mask pattern is written into electron beam resist layer 3 by selective computer-controlled electron beam radiation of that layer, as shown in FIG. 2. After a developing process, the irradiated areas of resist layer 3 are dissolved, leaving the pattern as shown in FIG. 2. An etching process is then applied, causing exposed areas of the chromium layer to be washed away. Finally, the remaining parts of electron beam resist layer 3 are dissolved away leaving the finished mask as illustrated in FIG. 3.

The particular pattern chosen for the mask is determined by dividing the area of the mask into numerous separate regions. For the sake of illustration, the mask of FIG. 3 has been divided into four separate regions, labelled A, B, C and D. Each region has a predetermined degree of transparency to UV radiation. Chromium layer 2 is opaque to UV radiation, so the degree of transparency of any particular region is determined by the number and size of holes in the chromium layer in that region. In the example of FIG. 3, region D has several large holes and therefore has a high degree of transparency, region B has no holes and therefore no transparency, and regions A and C fall between the two extremes. It should be noted that for the sake of simplification FIG. 3 shows only a few holes in each region, but in practice each region (other than regions differing transparencies of regions being determined solely by the sizes of the holes.

Also as indicated previously, instead of consisting of holes in the chromium layer, the mask may consist essentially of spots of chromium on an otherwise transparent substrate. In this case, the transparency of any region is determined by the size and number of spots in that region.

It is not necessary that the substrate for the mask be quartz or that the opaque material on the mask be chromium; these are merely the preferred examples of suitable materials. Any other suitable transparent and opaque materials may be used.

The next step in the microstructure fabrication process is shown in FIG. 4. The mask of FIG. 3 is inverted and placed near a thick layer of UV resist material 6 on a substrate 5. UV radiation 4 is then applied for a substantial period of time, typically between 20 minutes and one hour. It has been found that, using the method of the present invention, the effective depth of penetration by UV radiation in any region is related to the transparency of the corresponding mask region and the length of time of exposure. After exposure, a developer is applied to dissolve the areas of resist material penetrated by the UV radiation, leaving the photo-resist image illustrated in FIG. 5. In region D, where the level of exposure to UV radiation has been greatest, the resist has almost entirely disappeared, whereas in region B, where there was no exposure, the resist is intact. Regions A and C fall between the two extremes.

An additional aspect of the invention is that repeated exposure and development cycles can be made on the same layer or layers. This allows for finer patterns to be produced over coarser patterns upon additional exposure with a different mask.

The next step involves electroplating nickel onto the photo-resist image of FIG. 5, before dissolving away the remainder of UV resist material 6 and removing silicon substrate 5, resulting in the production of nickel shim 7, as shown in FIG. 6. This can then be used as the required microstructure, or as a master for replicating the microstructure according to known replication techniques.

As an alternative to the electroplating process, replication can be achieved by known reactive ion etching processes.

For illustration purposes, the nickel shim of FIG. 6 has relatively wide regions A, B, C and D. However, in practice the width of individual regions is relatively small compared to the average height or depth of regions. In other words, the majority of regions have a high aspect ratio. Each region forms a “structure element”, and in preferred arrangements structure elements typically have fixed lengths and widths and variable heights, with the height typically being at least three times the width and length. In typical presently available microstructures, such as the optically variable microstructure of International Patent Application PCT/AU94/00441 described above, each structural element has a height dimension of less than 0.5 micron. The present invention allows height dimensions of 10 to 20 micron or more.

In order to achieve significant height dimensions, or aspect ratios, the photo resist layer 6 is relatively thick. FIG. 5 illustrates a process for spin coating layers of high viscosity positive tone resist (preferred type AZ4000 series) onto a silicon substrate until a sufficiently thick coating has been achieved. The thick layer is then pre-baked before being used in the manner illustrated in FIG. 4.

In one application, the present invention can be used for converting a two-dimensional grey-scale image into a three-dimensional representation, in which lighter grey tones are represented by higher structural elements (or shallower pits) and darker grey tones are represented by lower structural elements (or deeper pits). This is done by mapping the grey scale values of individual pixels in the two-dimensional image to corresponding grey-scale values in the mask pattern, and applying the appropriate pattern to the mask. The mask, when held up to the light, constitutes a two dimensional reproduction of the original two-dimensional grey-scale image. Areas with a darker grey tone value have fewer or smaller holes, and areas with a lighter grey tone value have more or larger holes. Accordingly, when UV radiation is passed through the mask, radiation passing through regions with a darker grey tone value penetrates the resist to a lesser extent, resulting in shallower pits, and radiation passing through regions with a lighter grey tone value penetrates the resist to a greater extent, resulting in deeper pits.

The inverse effect can be obtained by mapping a pixel with a darker grey tone value to a mask region with a higher transparency to UV radiation, and mapping a pixel with a lighter grey tone value to a mask region with a lower transparency, so that the final structure is a “negative” image.

FIG. 8 is a highly magnified photograph of a microstructure according to an embodiment of the invention.

FIG. 9 is a photograph of another microstructure, being a three-dimensional representation of a grey-scale photographic image. FIG. 10 is a magnified region of the photograph of FIG. 9, showing the individual structural elements which make up the microstructure.

FIG. 11 shows another microstructure element according to another embodiment of the invention. In this case, the micro-aperture element consists of examples of very thin transparent tracks in which the variation in track width along each track length determines the variation in transparency of the track.

FIG. 12 shows another microstructure element according to another embodiment of the invention. In this case the micro-aperture element consists of examples of very thin opaque tracks in which the variation in track width along each track determines the variation in opaqueness of the track.

It will be appreciated from the description of the foregoing examples that many variations of the invention are possible. One particular variation applies the invention to diffractive optically variable devices.

Diffractive optically variable devices are described in above-mentioned International Patent Applications PCT/AU90/00395 and PGT/AU94/00441. As stated previously, they typically have a maximum structural element depth of around 0.5 micron, resulting in a low aspect ratio. These devices are typically embossed into a metal foil which is then attached to the surface of a document. It is desirable that the embossing process should be capable of being applied after a foil or lacquer has been applied to the surface of the document, but the fibres of the document paper surface may have height variations which are much greater than the variations in surface relief of the diffractive microstructure.

This problem can be addressed by a variation of the present invention, in which an embossing die is produced with alternating strips, bands, tracks or regions of high-aspect ratio structural elements (of the type to which the invention relates) and sub-micron diffractive surface relief microstructure elements.

FIG. 13 illustrates an embodiment in which strips or tracks 11 are composed or high aspect ratio structural elements, and alternating strips or tracks 12 are composed of low aspect ratio (sub-micron depth) diffractive surface relief microstructure elements. FIG. 14 shows a cross-section of an embossing die suitable for creating the embodiment of FIG. 13. The strips or tracks may be of any suitable width, with a width of around 30 microns being preferred.

The fabrication of the embossing die shown in FIG. 14 can be achieved by a variation of the process shown in FIGS. 1 to 4, in which a second mask carrying a diffractive pattern is produced and exposed in register with the first mask to produce the final structure. The fabrication of the first mask proceeds in the manner outlined above with reference to FIGS. 1 to 3, with the exception that only the regions corresponding to strips or tracks 11 on FIG. 13 are exposed to the electron beam. The fabrication of the second mask proceeds in the same manner, with only the regions corresponding to strips or tracks 12 on FIG. 13 being exposed to the electron beam. The exposure pattern on the regions corresponding to strips or tracks 12 is of a suitable diffractive type such as that described in International Application PCT/AU94/00441.

A substrate is then coated with a thick layer of UV sensitive resist and exposed to UV radiation through a double exposure process involving patterning the resist with the first and second masks in sequence and in register so that the thick resist layer generates a final exposure pattern corresponding to FIG. 13.

A modification of this procedure, for situations in which registration of the two masks cannot be ensured, involves creating the second mask with identical diffractive patterns in the positions corresponding to tracks 11 and track 12 on FIG. 13. One of the two versions of each pattern will effectively be “destroyed” by the high aspect ratio tracks of the first mask, while the other will survive, depending upon the set of tracks on the second mask to which the high aspect ratio tracks of the first mask most closely align.

The double mask mechanism allows the UV exposure of regions 11 and 12 to be varied independently so that the exposure of each region can be optimised to the requirements of the particular microstructure involved.

The final exposure pattern derived through the double mask exposure process is then developed and electroplated to give the embossing die of FIG. 14.

Many variations on the above process can be obtained using different geometries for defining the regions 11 and 12. For example, a chequerboard pattern could be used to define the regions rather than the track or strip configuration shown in FIG. 13. In such a case, the black squares could correspond to regions 11 and the white squares could correspond to regions 12.

In another arrangement, the geometry of some of the high aspect ratio regions could be arranged in such a configuration that embossing of those regions into a metallised lacquer results in an ability of the regions to resonate and/or scatter very high frequency radio waves.

A further variation of the invention can be achieved by modifying some of the diffractive regions to incorporate extremely small scale text or graphics elements that are only observable under a high power optical microscope.

It is to be understood that various alterations, additions and modifications may be made to the parts previously described without departing from the ambit of the invention.

1. A three-dimensional optical microstructure including a plurality of microstructure elements, each microstructure element having a width, a length and a height, wherein a significant proportion of the microstructure elements have height dimensions which exceed their width and length dimensions, and wherein the microstructure is a representation of a two-dimensional image composed of grey-scale pixels wherein each pixel in the two-dimensional image is represented by a microstructure element group in the three-dimensional microstructure and the grey-scale value of each pixel is represented by the height of the corresponding microstructure elements.

2. A three-dimensional optical microstructure including a plurality of microstructure elements, each microstructure element having a width, a length and a height, wherein a significant proportion of the microstructure elements have height dimensions which exceed their width dimensions, and wherein the microstructure is a representation of a two-dimensional image composed of grey-scale tracks, each track being composed of sections, wherein each track section in the two-dimensional image is represented by a microstructure element group in the three-dimensional microstructure and the grey-scale value at any point along each track is represented by the height of the corresponding microstructure elements.

3. A microstructure according to claim 1 wherein a majority of the microstructure elements have height dimensions which exceed their width and length dimensions by a factor of more than 3.

4. A microstructure according to claim I wherein the microstructure elements have fixed length and width dimensions but varying height dimensions.

5. A microstructure according to claim 1 or claim 2 wherein the microstructure elements have fixed length dimensions but variable width and height dimensions.

6. A microstructure according to claim 1 or claim 2 wherein the microstructure, when viewed by an observer, appears to contain one or more of: artistic patterns, line drawings, lettering, positive and negative photographic images, facial images, geometric patterns, company logos and optical elements.

7. A microstructure according to claim 6 wherein a first image is observed when the microstructure is viewed from a first viewing direction, and the first image switches to a second image when viewing angle moves from the first direction to a second direction, this effect being achieved as a result of sloped surfaces being provided on the tops of individual microstructure elements.

8. A microstructure according to claim 6 wherein the microstructure generates one or more non-diffractive images which are attributable to light being reflected and/or diffusely scattered from the topographic features of high-aspect microstructure elements of the type defined in claim 1, and also one or more diffractive images, the diffractive images being generated as a result of regions of diffractive microstructure elements being interposed between regions of high-aspect microstructure elements.

9. A microstructure according to claim 2, further including, interspersed between the grey-scale variable height tracks, further tracks of relatively fixed height which have diffractive surface relief structures which together upon illumination generate one or more optically variable diffractive images which vary according to the angle of view or angle of illumination of the microstructure.

10. A method of fabricating a microstructure according to claim 8 including the steps of:
(a) Forming a first mask with a plurality of regions, each region having a predetermined degree of transparency to UV radiation and each region being adjacent to a region opaque to UV radiation;
(b) Forming a second mask with a plurality of diffractive regions, each region containing a plurality of diffractive grooves or polygons, wherein each diffractive region is directly adjacent a region opaque to UV radiation and each diffractive region corresponds in geometric size and location to an opaque region of the first mask
(c) Providing a substrate coated with a thick layer of UV resist material;
(d) Using UV radiation to irradiate through each of the regions of the first mask and the second mask a corresponding region of the layer of UV resist, with the same or different exposure levels being applied to the two masks; and
(e) Developing the layer of UV resist to remove irradiated regions, wherein the depth of each region exposed through the first mask is dependent upon the degree of transparency of the corresponding region of the mask, and the depth and variation in depth of each region exposed through the second mask is characterised by the diffractive properties of the corresponding regions of the second mask.

11. A method of fabricating a microstructure including the steps of:
(a) Forming a mask with a plurality of regions, each region having a predetermined degree of transparency to UV radiation;
(b) Providing a substrate coated with a thick layer of UV resist material;
(c) Using UV radiation to irradiate through each of the regions of the mask a corresponding region of the layer of UV resist; and
(d) Developing the layer of UV resist to remove irradiated regions, wherein the depth of each region is dependent upon the degree of transparency of the corresponding region of the mask.

12. A method according to claim 11 wherein each region of the mask consists of one of:
(a) Material which is opaque to transmission of UV radiation, but which includes a plurality of transparent holes, with the overall degree of transparency of the region being determined by the number and size of the holes; or
(b) Material which is transparent to UV radiation, but which includes a plurality of opaque spots, with the overall degree of transparency of the region being determined by the number and size of the spots; or
(c) Material which is opaque to transmission of UV radiation, but which includes a plurality of transparent strips or tracks, with the overall degree of transparency of the region being determined by the width and variation in width of each track; or
(d) Material which is transparent to UV radiation, but which includes a plurality of opaque strips or tracks, with the overall degree of transparency of the region being determined by the width and variation in width of each track.

13. A method according to claim 12 wherein the holes or spots have the same constant spacing for each region and the overall degree of transparency of each region is determined by the size of the holes or spots.

14. A method according to claim 12 wherein the transparent or opaque tracks have the same constant spacing for each region and the overall degree of transparency of each region is determined by the variation in width along each track.

15. A method according to claim 11 wherein the layer of UV resist has a thickness of 10 micron or greater.

16. A method according to claim 11 wherein the layer of UV resist comprises two or more types of different resists in individual layers, allowing variation in the physical characteristics of structure elements at different depths in the structure.

17. A method according to claim 11 including the further additional step:
(e) Replicating the microstructure by means of reactive ion etching and/or electroplating.

18. A microstructure formed according to the method of claim 11.

19. A three dimensional microstructure according to claim 1 which is used as an embossing die to produce a reflective and/or diffractive image on a document which has previously been coated with an embossable lacquer or foil, or which otherwise incorporates an embossable surface, to enable the three-dimensional microstructure on the embossing die to be replicated on the document.

20. A document such as a cheque, plastic film, banknote, share certificate or other substrate, which has a three-dimensional pattern embossed into it by means of a three-dimensional microstructure according to claim 1 or claim 2.

21. A microstructure according to claim 5 which is replicated by embossing into polymer type substrates, and the resulting image generating substrate incorporated into or attached to a document or commercial product and used as an authenticating or anti-counterfeiting image to signify the authenticity of the document or product.
